(19) United States
(12) Patent Application Publication
(10) Pub. No.: US 2026/0292148 A1
(43) Pub. Date: Sep. 24, 2026

(54) Methods and Apparatus of Filtered Predictors for IntraTMP, IBC, or LIC Mode in Video Coding

(71) Applicant: MEDIATEK INC., Hsinchu City (TW)

(72) Inventors: Wen-Chun LIN, Hsinchu City (TW); Ching-Yeh CHEN, Hsinchu City (TW); Chih-Wei HSU, Hsinchu City (TW); Yi-Wen CHEN, San Jose, CA (US); Tzu-Der CHUANG, Hsinchu City (TW)

(21) Appl. No.: 19/471,794

(22) PCT Filed: Apr. 7, 2024
(86) PCT No.: PCT/CN2024/086336

§ 371 Date: Oct. 2, 2025

Related U.S. Application Data
(60) Provisional application No. 63/497,755, filed on Apr. 24, 2023.

(51) Int. Cl. H04N 19/11; H04N 19/105; H04N 19/132; H04N 19/176; H04N 19/182; H04N 19/593

(52) U.S. Cl. CPC H04N 19/11; H04N 19/105; H04N 19/132; H04N 19/176; H04N 19/182; H04N 19/593

(57) ABSTRACT

A method and apparatus for video coding using filtered predictors for IntraTMP, IBC and/or LIC mode are disclosed. According to the method, one or more reference templates for a reference block and one or more current templates for the current block are determined. A prediction model for predicting a target current sample in the current block is derived based on reference data, wherein the prediction model comprises one or more target reference samples and one or more gradient terms derived from the reference data, and wherein parameters of the prediction model are determined based on said one or more reference templates and said one or more current templates. A target predictor for the target current sample in the current block is generated according to the prediction model. The target current sample in the current block is encoded or decoded using the target predictor.

### CROSS REFERENCE TO RELATED APPLICATIONS

The present invention is a non-Provisional Application of and claims priority to U.S. Provisional Patent Application No. 63/497,755, filed on Apr. 24, 2023. The U.S. Provisional Patent Application is hereby incorporated by reference in its entirety.

### FIELD OF THE INVENTION

The present invention relates to video coding system. In particular, the present invention relates to filtered predictors for IntraTMP, IBC, or LIC mode in a video coding system.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

### Intra Block Copy

Intra block copy (IBC) is a tool adopted in HEVC extensions on SCC (Screen Content Coding). It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector is rounded to integer precision as well. When combined with AMVR (Adaptive Motion Vector Resolution), the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return a valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signalled as IBC AMVP (Advanced Motion Vector Prediction) mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP (History based Motion Vector Prediction), and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.

### IBC Reference Region

To reduce memory consumption and decoder complexity, the IBC in VVC allows only the reconstructed portion of the predefined area including the region of current CTU and some region of the left CTU. FIG. 2 illustrates the reference region of IBC Mode, where each block represents 64×64 luma sample unit. Depending on the location of the current coded CU within the current CTU, the following applies:
If the current block falls into the top-left 64×64 block of the current CTU (case 210 in FIG. 2), then in addition to the already reconstructed samples in the current CTU, it can also refer to the reference samples in the top-right, bottom-left, and bottom-right 64×64 blocks of the left CTU, using current picture referencing (CPR) mode. (More details of CPR can be found in JVET-T2002 (Jianle Chen, et. al., “Algorithm description for Versatile Video Coding and Test Model 11 (VTM 11)”, Joint Video Experts Team (JVET) of ITU-T SG 16 WP 3 and ISO/IEC JTC 1/SC 29, 20th Meeting, by teleconference, 7-16 Oct. 2020, Document: JVET-T2002)). The current block can also refer to the reference samples in the top-right, bottom-left, and bottom-left 64×64 block of the left CTU and the reference samples in the top-right 64×64 block of the current CTU, using CPR mode.
If the current block falls into the top-right 64×64 block of the current CTU (case 220 in FIG. 2), then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
If the current block falls into the bottom-left 64×64 block of the current CTU (case 230 in FIG. 2), then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
If current block falls into the bottom-right 64×64 block of the current CTU (case 240 in FIG. 2), it can only refer to the already reconstructed samples in the current CTU, using CPR mode.

### Intra Template Matching Prediction (IntraTMP) Mode

Intra template matching prediction (IntraTMP) is a special intra prediction mode that copies the best prediction block from the reconstructed part of the current frame, whose L-shaped template matches the current template. For a predefined search range, the encoder searches for the most similar template matched with the current template in a reconstructed part of the current frame and uses the corresponding block as a prediction block. The encoder then signals the usage of this mode, and the same prediction operation is performed at the decoder side.

The prediction signal is generated by matching the L-shaped causal neighbour of the current block with another block in a predefined search area in FIG. 3 consisting of current CTU (R1), top-left CTU (R2), above CTU (R3), left CTU (R4). Sum of absolute differences (SAD) is used as a cost function. Within each region, the decoder searches for the template that has least SAD with respect to the current one and uses its corresponding block as a prediction block.

In FIG. 3, the current block 310 in R1 is matched with the corresponding block 312 in R2. The templates for the current block and the matched block are shown as darker-colour L-shaped areas. Area 322 corresponds to reconstructed region in the current picture 320. Sum of absolute differences (SAD) is used as a cost function. Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$SearchRange\_w = a * BlkW ,$$

$$SearchRange\_h = a * BlkH ,$$

where ‘a’ is a constant that controls the gain/complexity trade-off. In practice, ‘a’ is equal to 5.

To speed-up the template matching process, the search range of all search regions is subsampled by a factor of 2. This leads to a reduction of template matching search by 4. After finding the best match, a refinement process is performed. The refinement is done via a second template matching search around the best match with a reduced range. The reduced range is defined as min(BlkW, BlkH)/2.

The Intra template matching tool is enabled for CUs with size less than or equal to 64 in width and height. This maximum CU size for Intra template matching is configurable.

The Intra template matching prediction mode is signalled at CU level through a dedicated flag when DIMD (Decoder-side Intra Mode Derivation) is not used for current CU.

### IntraTMP Derived Block Vector Candidates for IBC

In this method, block vector (BV) derived from the intra template matching prediction (IntraTMP) is used for intra block copy (IBC). The stored IntraTMP BV of the neighbouring blocks along with IBC BV are used as spatial BV candidates in IBC candidate list construction.

IntraTMP block vector is stored in the IBC block vector buffer and, the current IBC block can use both IBC BV and IntraTMP BV of neighbouring blocks as BV candidates for IBC BV candidate list as shown in FIG. 4.

In FIG. 4, block 410 corresponds to the current block and block 412 corresponds to a neighbouring IntraTMP block. The IntraTMP BV 416 is used to locate the best matching block 422 according to the matching cost between template 424 and template 414. Area 432 corresponds to reconstructed region in the current picture 430. IntraTMP block vectors are added to IBC block vector candidate list as spatial candidates.

IntraTMP block vectors are added to IBC block vector candidate list as spatial candidates.

### A Model Trained by Templates for IntraTMP and IBC

In recent development, templates have been used for IntraTMP and IBC to help searching for the best reference block as a prediction block for the current block. According to this new technique, a model is trained by using data in the templates to obtain a better prediction. According to this technique, the prediction of the current block is not directly copied from the reference block. Instead, filtered values obtained by the trained model are considered instead.

### A. Model Used in IBC

In IBC, a single source model containing a spatial term is used:

$$y = {a}_{0} {x}_{0} + offset , \qquad ( 1 )$$

where y is in the current template or the current block, and x₀ is the corresponding pixel of y in the reference template or the reference block for training and inference stages, respectively. a₀ and offset are parameters of the model. During the training stage, the training dataset contains all the data in the reference and current templates. The pairs of (x₀, y) are fed into the model to train the parameters a₀ and offset. In the inference stage, the prediction block can be produced by the model with trained parameters a₀ and offset when all the pixel values of the current block are fed into the model. As shown in equation (1), the filtered predictor for IBC is a single-source predictor since only 1 input term (i.e., x₀) is used.

FIG. 5A and FIG. 5B illustrate an example of model training and trained-model prediction respectively for IBC using a single source model containing a spatial term. In FIG. 5A, the current template 512 for the current block 510 and the reference template 522 for the reference block 520 are used to train the model. A prediction model is derived after the training. In other words, a sample, y in the current template can be related to a corresponding sample, x₀ in the reference template as shown in FIG. 5A according to equation (1). After the model is derived, the model is used in the inference stage to prediction a sample, y in the current block according to a corresponding sample, x₀ in the reference block as shown in FIG. 5B using equation (1).

### B. Model Used in IntraTMP

In IntraTMP, a multi-source model containing more than one spatial term is used:

$$y = {\sum }_{i = 0}^{n} {a}_{i} {x}_{i} + offset , \qquad ( 2 )$$

where y is in the current template or the current block and x₀, x₁, . . . , xₙ are in the reference template or the reference block for training and inference stages, respectively. For the multi-source model, not only x₀, the corresponding reference pixel of the current pixel, but also the neighbouring pixels of x₀ are used. For example, the top, bottom, left and right pixels of x₀ are also considered to be one of training inputs. In addition, a₀, a₁, . . . , aₙ and offset are parameters of the model. During the training stage, the training dataset contains all the data in the reference and current templates. The sets of (x₀, x₁, . . . , xₙ, y) are fed into the model to train the parameters a₀, a₁, . . . , aₙ and offset. In the inference stage, the prediction block can be produced by the model with trained parameters a₀, a₁, . . . , aₙ and offset when all the pixel values of the current block are fed into the model.

FIG. 6A and FIG. 6B illustrate an example of model training and trained-model prediction respectively for IntraTMP using a multiple-source model containing multiple spatial terms. In FIG. 6A, the current template 612 for the current block 610 and the reference template 622 for the reference block 620 are used to train the model. A prediction model is derived after the training. In other words, a sample, y in the current template can be related to corresponding samples, x₀, x₁, . . . , xₙ in the reference template as shown in FIG. 6A according to equation (2). After the model is derived, the model is used in the inference stage to prediction a sample, y in the current block according to corresponding sample, x₀, x₁, . . . , xₙ in the reference block as shown in FIG. 6B using equation (2).

### Local Illumination Compensation (LIC)

Local Illumination Compensation (LIC) is a method to perform inter prediction by using neighbouring samples of the current block and reference block based on a linear model with a scaling factor a and an offset b. It derives the scaling factor a and the offset b by referring to the neighbouring samples of the current block and reference block. Moreover, it's enabled or disabled adaptively for each CU. More details for LIC can be found in JVET-C1001 (Jianle Chen, et. al., “Algorithm Description of Joint Exploration Test Model 3”, Joint Video Experts Team (JVET) of ITU-T SG 16 WP 3 and ISO/IEC JTC 1/SC 29, 3rd Meeting: Geneva, CH, 26 May-1 Jun. 2016, Document: JVET-C1001).

In the present invention, methods and apparatus of new filtered predictors for IntraTMP, IBC and/or LIC are disclosed to improve the performance.

### BRIEF SUMMARY OF THE INVENTION

A method and apparatus for video coding using filtered predictors for IntraTMP, IBC and/or LIC mode are disclosed. According to the method, input data associated with a current block are received, wherein the input data comprises pixel data to be encoded at an encoder side or coded data associated with the current block to be decoded at a decoder side. One or more reference templates for a reference block and one or more current templates for the current block are determined. A prediction model for predicting a target current sample in the current block is derived based on reference data, wherein the prediction model comprises one or more target reference samples and one or more gradient terms derived from the reference data, and wherein parameters of the prediction model are determined based on said one or more reference templates and said one or more current templates. A target predictor for the target current sample in the current block is generated according to the prediction model. The target current sample in the current block is encoded or decoded using the target predictor.

In one embodiment, the current block is coded in IntraTMP (intra Template Matching Prediction), IBC (Intra Block Copy) or LIC (Local Illumination Compensation) mode.

In one embodiment, said one or more gradient terms comprise a vertical gradient and a horizontal gradient.

In one embodiment, said one or more target reference samples comprise a corresponding reference sample for the target current sample, a top reference sample, a bottom reference sample, a left reference sample, and a right reference sample of the corresponding reference sample. In one embodiment, a vertical gradient is calculated according to a first difference between the top reference sample and the bottom reference sample, and a horizontal gradient is calculated based on a second difference between the left reference sample and the right reference sample. In one embodiment, said one or more target reference samples further comprise a top-right reference sample, a top-left reference sample, a bottom-left reference sample, and a bottom-right reference sample of the target current sample. In one embodiment, a vertical gradient is calculated according to a first difference between a first sum of the top reference sample, the top-right reference sample and the top-left reference sample and a second sum of the bottom reference sample, the bottom-right reference sample and the bottom-left reference sample, and a horizontal gradient is calculated based on a second difference between a third sum of the left reference sample, the top-left reference sample and the bottom-left reference sample, and a fourth sum of the right reference sample, the top-right reference sample and the bottom-right reference sample.

In one embodiment, said one or more target reference samples or said one or more gradient terms are clipped. In one embodiment, said one or more target reference samples comprise a corresponding reference sample for the target current sample, intensities of said one or more target reference samples except for the corresponding reference sample are clipped according to a target intensity of the corresponding reference sample. In one embodiment, the intensities of said one or more target reference samples except for the corresponding reference sample are clipped to a range within a threshold from the target intensity of the corresponding reference sample, wherein the threshold has a positive value. In one embodiment, the threshold is pre-defined. In one embodiment, the threshold is dependent on sample bit-depth, slice type, CU width, CU height, prediction direction, quantization parameter, or a combination thereof. In one embodiment, the threshold is explicitly signalled or parsed at CU level, CTU level, slice level, picture level, or sequence level.

In one embodiment, intensities of said one or more gradient terms are clipped to a range within a threshold from 0, and wherein the threshold has a positive value. In one embodiment, the threshold is pre-defined. In one embodiment, the threshold is dependent on sample bit-depth, slice type, CU width, CU height, prediction direction, quantization parameter, or a combination thereof. In one embodiment, the threshold is explicitly signalled or parsed at CU level, CTU level, slice level, picture level, or sequence level.

According to another method, input data associated with a current block are received, wherein the input data comprises pixel data to be encoded at an encoder side or coded data associated with the current block to be decoded at a decoder side. One or more reference templates for a reference block and one or more current templates for the current block are determined. A prediction model for predicting a target current sample in the current block is derived based on reference data, wherein the prediction model comprises multiple target reference samples if the current block is coded in IBC (Intra Block Copy) or LIC (Local Illumination Compensation) mode, and the prediction model comprises a single target reference sample if the current block is coded in IntraTMP (intra Template Matching Prediction) mode, and wherein parameters of the prediction model are determined based on said one or more reference templates and said one or more current templates. A target predictor for the target current sample in the current block is generated according to the prediction model. The target current sample in the current block is encoded or decoded using the target predictor.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates an example of current CTU processing order and its available reference samples in current and left CTU.

FIG. 3 illustrates an example of intra template matching search area used.

FIG. 4 illustrates an example of use of IntraTMP block vector for IBC block.

FIG. 5A illustrates an example of a training pair using a single source model containing a single spatial term.

FIG. 5B illustrates an example of an inference pair using a single source model containing a single spatial term.

FIG. 6A illustrates an example of a training pair using a multiple source model containing multiple spatial terms.

FIG. 6B illustrates an example of an inference pair using a multiple source model containing multiple spatial terms.

FIG. 7A illustrates an example of a training set using a multi-source model containing spatial and gradient terms in IntraTMP or IBC.

FIG. 7B illustrates an example of an inference set using a multi-source model containing spatial and gradient terms in IntraTMP or IBC.

FIG. 8A illustrates an example of a training pair using a multiple source model containing multiple spatial terms in LIC.

FIG. 8B illustrates an example of an inference pair using a multiple source model containing multiple spatial terms in LIC.

FIG. 9A illustrates an example of a training set using a multi-source model containing spatial and gradient terms in LIC.

FIG. 9B illustrates an example of an inference set using a multi-source model containing spatial and gradient terms in LIC.

FIG. 10 illustrates a flowchart of an exemplary video coding system that uses filtered predictors with a prediction model including multiple spatial terms and gradient terms according to an embodiment of the present invention.

FIG. 11 illustrates a flowchart of another exemplary video coding system that uses filtered predictors with a single source or multiple source prediction model according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In the present invention, methods and apparatus of new filtered predictors for IntraTMP, IBC and/or LIC are disclosed to improve the performance.

a Single Source Model Trained by Spatial Information from Templates for IntraTMP

In one embodiment, a single source model containing a spatial term is used:

$$y = {a}_{0} {x}_{0} + offset , \qquad ( 3 )$$

where y is in the current template or the current block, and x₀ is the corresponding pixel of y in the reference template or the reference block for training and inference stages, respectively. a₀ and offset are parameters of the model. During the training stage, the training dataset contains all the data in the reference and current templates. The pairs of (x₀, y) are fed into the model to train the parameters a₀ and offset. In the inference stage, the prediction block can be produced by the model with trained parameters a₀ and offset when all the pixel values of the current block are fed into the model. As shown in equation (3), the filtered predictor for IBC is a single-source predictor since only 1 input term (i.e., x₀) is used.

FIG. 5A and FIG. 5B illustrate an example of model training and trained-model prediction respectively for IntraTMP using a single source model containing a spatial term. In FIG. 5A, the current template 512 for the current block 510 and the reference template 522 for the reference block 520 are used to train the model. A prediction model is derived after the training. In other words, a sample, y in the current template can be related to a corresponding sample, x₀ in the reference template as shown in FIG. 5A according to equation (3). After the model is derived, the model is used in the inference stage to prediction a sample, y in the current block according to a corresponding sample, x₀ in the reference block as shown in FIG. 5B using equation (3).

A Multi-Source Model Trained by Spatial Information from Templates for IBC

In one embodiment, a multi-source model containing more than one spatial term is used for IBC:

$$y = {\sum }_{i = 0}^{n} {a}_{i} {x}_{i} + offset , \qquad ( 4 )$$

where y is in the current template or the current block and x₀, x₁, . . . , xₙ are in the reference template or the reference block for training and inference stages, respectively. For the multi-source model, not only x₀, the corresponding reference pixel of the current pixel, but also the neighbouring pixels of x₀ are used. For example, the top, bottom, left and right pixels of x₀ are also considered to be one of training inputs. In addition, a₀, a₁, . . . , aₙ and offset are parameters of the model. During the training stage, the training dataset contains all the data in the reference and current templates. The sets of (x₀, x₁, . . . , xₙ, y) are fed into the model to train the parameters a₀, a₁, . . . , aₙ and offset. In the inference stage, the prediction block can be produced by the model with trained parameters a₀, a₁, . . . , aₙ and offset when all the pixel values of the current block are fed into the model.

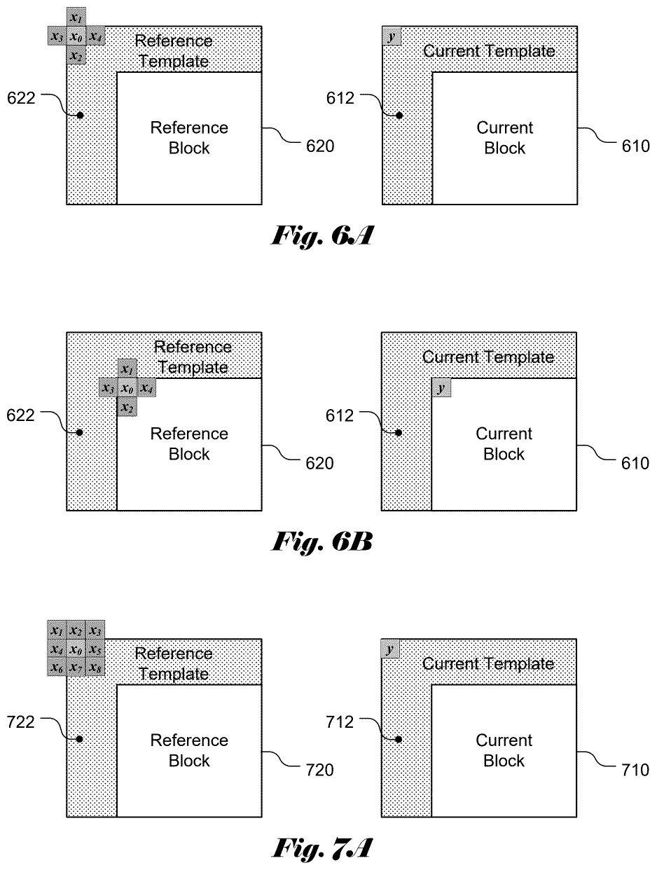

FIG. 6A and FIG. 6B illustrate an example of model training and trained-model prediction respectively for IBC using a multiple-source model containing multiple spatial terms. In FIG. 6A, the current template 612 for the current block 610 and the reference template 622 for the reference block 620 are used to train the model. A prediction model is derived after the training. In other words, a sample, y in the current template can be related to corresponding samples, x₀, x₁, . . . , xₙ in the reference template as shown in FIG. 6A according to equation (4). After the model is derived, the model is used in the inference stage to prediction a sample, y in the current block according to corresponding sample, x₀, x₁, . . . , xₙ in the reference block as shown in FIG. 6B using equation (4).

A Multi-Source Model Trained by Spatial and Gradient Information from Templates for IntraTMP and IBC

In one embodiment, a multi-source model containing spatial and gradient terms is used:

$$y = {\sum }_{i = 0}^{n} {a}_{i} {x}_{i} + {\sum }_{j = 0}^{m} {b}_{j} {g}_{j} + offset , \qquad ( 5 )$$

where y is in the current template or the current block and x₀, x₁, . . . , xₙ are in the reference template or the reference block for training and inference stages, respectively. x₀ is the corresponding reference pixel of the current pixel y, and x₁, . . . , xₙ are the neighbouring pixels of x₀. g₀, g₁, . . . , gₘ are the gradient terms calculated from the reference pixels.

In one example, g₀ corresponds to vertical gradient and g₁ corresponds to horizontal gradient. For example, a simple vertical gradient can be acquired by calculating the difference between the top and bottom pixels of x₀. That is, if x₂ is the top pixel of x₀ and x₇ is the bottom pixel of x₀, vertical gradient is x₇−x₂.

If a more complicated vertical gradient is needed, it can be generated by ((x₆+x₇+x₈)−(x₁+x₂+x₃))/3, where x₁ is the top left pixel of x₀, x₂ is the top pixel of x₀, x₃ is the top right pixel of x₀, x₆ is the bottom left pixel of x₀, x₇ is the bottom pixel of x₀, and x₈ is the bottom right pixel of x₀. Accordingly, the vertical gradient in the above examples is

$${g}_{0} = {x}_{7} - {x}_{2} , or$$

$${g}_{0} = ( ( {x}_{6} + {x}_{7} + {x}_{8} ) - ( {x}_{1} + {x}_{2} + {x}_{3} ) ) / 3 .$$

For another example, horizontal gradient can be generated by x₅−x₄ or ((x₃+x₅+x₈)−(x₁+x₄+x₆))/3 according to users. Here, x₁ is the top left pixel of x₀, x₃ is the top right pixel of x₀, x₄ is the left pixel of x₀, x₅ is the right pixel of x₀, x₆ is the bottom left pixel of x₀, and x₈ is the bottom right pixel of x₀. Moreover, the gradients can be other directions such as diagonal gradient or any angular gradients. Accordingly, the horizontal gradient in the above examples is

$${g}_{1} = {x}_{5} - {x}_{4} , or$$

$${g}_{1} = ( ( {x}_{3} + {x}_{5} + {x}_{8} ) - ( {x}_{1} + {x}_{4} + {x}_{6} ) ) / 3 .$$

In addition, the range of usable pixels can depend on the size of CU. For example, the set of xₙ can be the samples within a k×k block which centres at x₀, where k is larger when size of CU is larger.

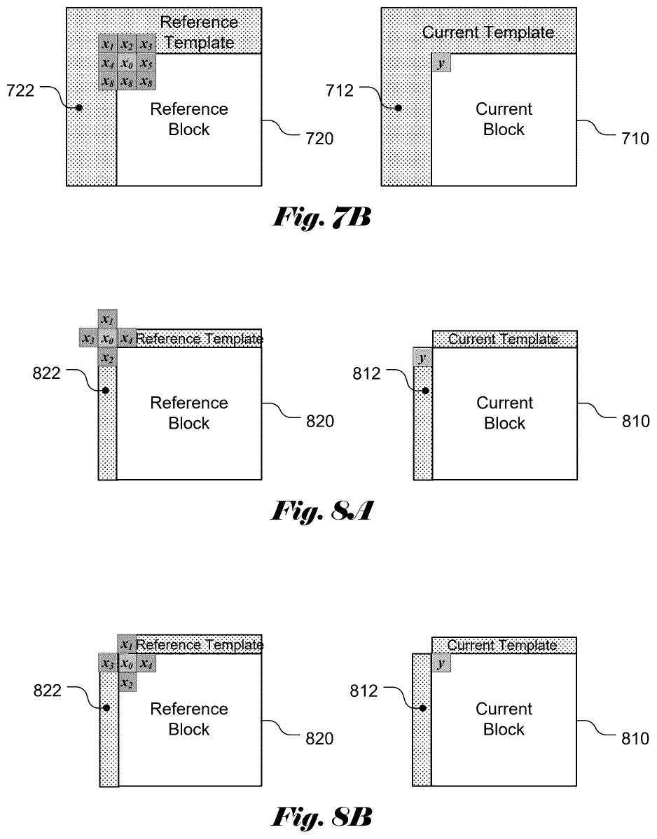

For this model, the training dataset contains calculated gradients and the data in the reference and current templates. The sets of (x₀, x₁, . . . , xₙ, g₀, g₁, . . . , gₘ, y) are fed into the model to train the parameters a₀, a₁, . . . , aₙ, b₀, b₁, . . . , bₘ and offset. In the inference stage, the prediction block can be produced by the model with trained parameters a₀, a₁, . . . , aₙ, b₀, b₁, . . . , bₘ and offset when the pixel values of the current block are fed into the model. The surrounding samples x₀, x₁, . . . , x₈ in the above examples for IntraTMP or IBC are shown in FIG. 7A, where the current template 712 for the current block 710 and the reference template 722 for the reference block 720 are used to train the model. FIG. 7B illustrates an example of inference stage corresponding to the training model in FIG. 7A for IntraTMP or IBC. In FIG. 7B, the model trained based on the current template 712 and the reference template 722 are used to predict a sample in the current block 710 based on corresponding samples in the reference block 720.

In the proposed method, no additional information should be signalled since parameters of the model can be derived by decoder. A model can be ready once the reference template and the current template can be accessed.

### A Multi-Source Model in LIC

In LIC, a linear model with a scaling factor and an offset is used for inter prediction. To get the better prediction, multi-source models are proposed.

In one embodiment, a multi-source model containing more than one spatial term is used:

$$y = {\sum }_{i = 0}^{n} {a}_{i} {x}_{i} + offset , \qquad ( 6 )$$

where y is in the current template, which is the neighbouring sample of the current block, or in the current block and x₀, x₁, . . . , xₙ are in the reference template, which are the neighbouring samples of the reference block, or in the reference block for training and inference stages, respectively. In this model, not only x₀, the corresponding reference sample of the current sample y, but also the neighbouring pixels of x₀ are used. For example, the top (x₁), bottom (x₂), left (x₃) and right (x₄) samples of x₀ are also considered to be the inputs of the model as shown in FIG. 8A for the training stage and FIG. 8B for the inference stage. In FIG. 8A, the current template 812 for the current block 810 and the reference template 822 for the reference block 820 are shown. In FIG. 8B, the current template 812 for the current block 810 and the reference template 822 for the reference block 820 are shown.

During the training stage, the sets of (x₀, x₁, . . . , xₙ, y) are fed into the model to train the parameters a₀, a₁, . . . , aₙ and offset. In the inference stage, the prediction block can be produced by the model with trained parameters a₀, a₁, . . . , aₙ and offset when the pixel values of the current block are fed into the model.

In another embodiment, a multi-source model containing spatial and gradient terms is used:

$$y = {\sum }_{i = 0}^{n} {a}_{i} {x}_{i} + {\sum }_{j = 0}^{m} {b}_{j} {g}_{j} + offset , \qquad ( 7 )$$

where y is in the current template, which is the neighbouring sample of the current block, or in the current block and x₀, x₁, . . . , xₙ are in the reference template, which are the neighbouring samples of the reference block, or in the reference block for training and inference stages, respectively. x₀ is the corresponding reference sample of the current sample y, and x₁, . . . , xₙ are the neighbouring pixels of x₀. g₀, g₁, . . . , gₘ are the gradient terms calculated from reference samples.

In one example, g₀ corresponds to vertical gradient and g₁ corresponds to horizontal gradient. For example, the typical gradients such as vertical and horizontal gradients can be acquired easily. When x₂ is the top pixel of x₀ and x₇ is the bottom pixel of x₀, vertical gradient is x₇−x₂. When x₄ is the left pixel of x₀ and x₅ is the right pixel of x₀, horizontal gradient is x₅−x₄. Alternately, a more complicated vertical gradient can be calculated by ((x₆+x₇+x₈)−(x₁+x₂+x₃))/3 where x₁ is the top left pixel of x₀, x₂ is the top pixel of x₀, x₃ is the top right pixel of x₀, x₆ is the bottom left pixel of x₀, x₇ is the bottom pixel of x₀, and x₈ is the bottom right pixel of x₀. A more complicated horizontal gradient can be generated by ((x₃+x₅+x₈)−(x₁+x₄+x₆))/3, where x₁ is the top left pixel of x₀, x₃ is the top right pixel of x₀, x₄ is the left pixel of x₀, x₅ is the right pixel of x₀, x₆ is the bottom left pixel of x₀, and x₈ is the bottom right pixel of x₀. Moreover, the gradients can be other directions such as diagonal gradient or any angular gradients. Accordingly, the vertical gradient and horizontal gradient in the above examples are:

$${g}_{0} = \{ \begin{matrix}{x}_{7} - {x}_{2} , or \\ ( ( {x}_{6} + {x}_{7} + {x}_{8} ) - ( {x}_{1} + {x}_{2} + {x}_{3} ) ) / 3\end{matrix}$$

$${g}_{1} = \{ \begin{matrix}{x}_{5} - {x}_{4} , or \\ ( ( {x}_{3} + {x}_{5} + {x}_{8} ) - ( {x}_{1} + {x}_{4} + {x}_{6} ) ) / 3\end{matrix} .$$

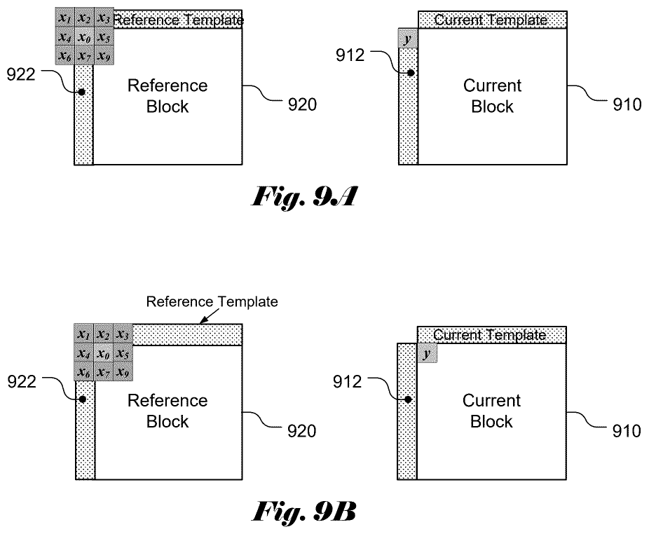

For this model, the training dataset contains calculated gradients and the data in the reference and current templates. The sets of (x₀, x₁, . . . , xₙ, g₀, g₁, . . . , gₘ, Y) are fed into the model to train the parameters a₀, a₁, . . . , aₙ, b₀, b₁, . . . , bₘ and offset. In the inference stage, the prediction block can be produced by the model with trained parameters a₀, a₁, . . . , aₙ, b₀, b₁, . . . , bₘ and offset when the pixel values of the current block are fed into the model. The surrounding samples x₀, x₁, . . . , x₈ in the above examples for LIC are shown in FIG. 9A, where the current template 912 for the current block 910 and the reference template 922 for the reference block 920 are used to train the model. FIG. 9B illustrates an example of inference stage corresponding to the training model in FIG. 9A for LIC. In FIG. 9B, the model trained based on the current template 912 and the reference template 922 are used to predict a sample in the current block 910 based on corresponding samples in the reference block 920.

The proposed multi-source models can be viewed as extended versions of the original design for LIC. The number of the model inputs is expanded without increasing the total number of training data. In other words, the training data still come from the reference and the current templates. Therefore, no additional information will be signalled, and the parameters of the model can be derived by decoder.

### Clipping Operation in the Filter Footprint

To properly train the multi-source model, the training data should be reliable. Here, a clipping operation is introduced to the multi-source model to reduce the outliers. In other words, the spatial training data should be clipped more for the multi-source model containing than the one spatial term. The spatial and/or gradient training data should be clipped for the multi-source model containing spatial and gradient terms.

In the proposed method, the intensities of neighbouring samples x₁, x₂, . . . , xₙ are clipped with reference to the intensity of the centre sample x₀:

$${x}_{i}^{′} = \{ \begin{matrix}{x}_{0} - {th}_{s} , & if {x}_{i} < ( {x}_{0} - {th}_{s} ) \\ {x}_{0} + {th}_{s} , & if {x}_{i} > ( {x}_{0} + {th}_{s} ) \\ {x}_{i} , & otherwise\end{matrix} , i = 1 , 2 , … , n$$

where xᵢ is the neighbouring sample of x₀ and x′ᵢ is the clipped value of xᵢ. thₛ is a threshold that determines whether the intensity of neighbouring sample xᵢ is close to the centre sample x₀. While the intensity difference between xᵢ and xₒ is larger than thₛ, it identifies that xᵢ and xₒ are not similar. Under this situation, the neighbouring sample is clipped within the range of x₀−thₛ to x₀+thₛ. In one embodiment, thₛ is a predefined value which can depend on sample bit-depth, slice type, CU width/height, prediction direction, and/or quantization parameter. In another embodiment, thₑ is explicitly signalled at CU level, CTU level, slice level, picture level, or sequence level.

For the gradient terms, the intensities are clipped by a threshold thy:

$${g}_{j}^{′} = \{ \begin{matrix}- {th}_{g} , & if {g}_{j} < ( - {th}_{g} ) \\ {th}_{g} , & if {g}_{j} > {th}_{g} \\ {g}_{j} , & otherwise\end{matrix} , j = 0 , 1 , 2 , … , m$$

where gⱼ is the gradient term calculated by reference pixels and g′ⱼ is the clipped gradient term. th_{g} is a threshold that decides whether the gradient is smooth or sharp. The sharp gradient should be avoided to reduce the fluctuation. Therefore, the gradient is clipped within the range of −th_{g} to th_{g}. In one embodiment, th_{g} is a predefined value which can depend on sample bit-depth, slice type, CU width/height, prediction direction, and/or quantization parameter. In another embodiment, th_{g} is explicitly signalled at CU level, CTU level, slice level, picture level, or sequence level.

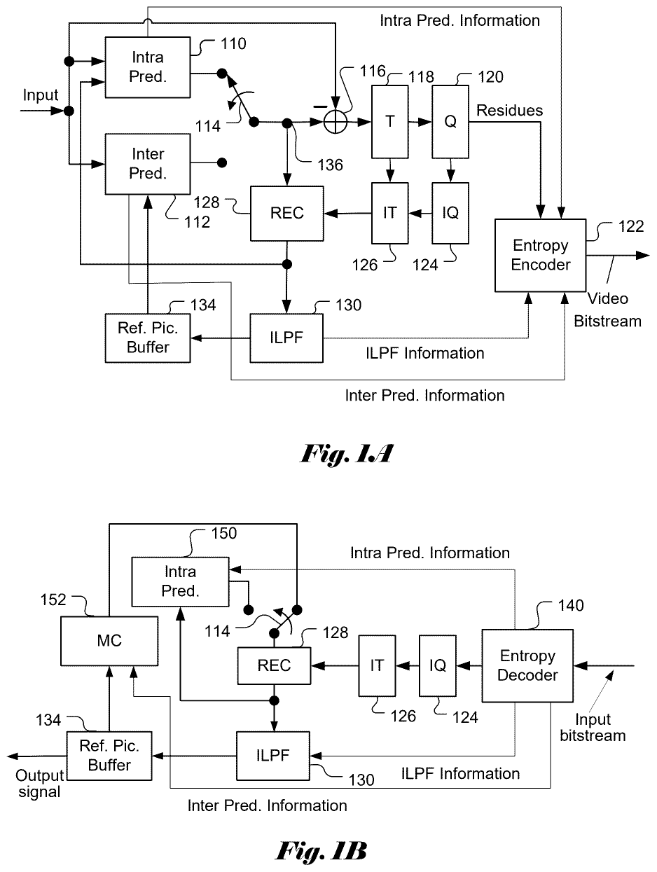

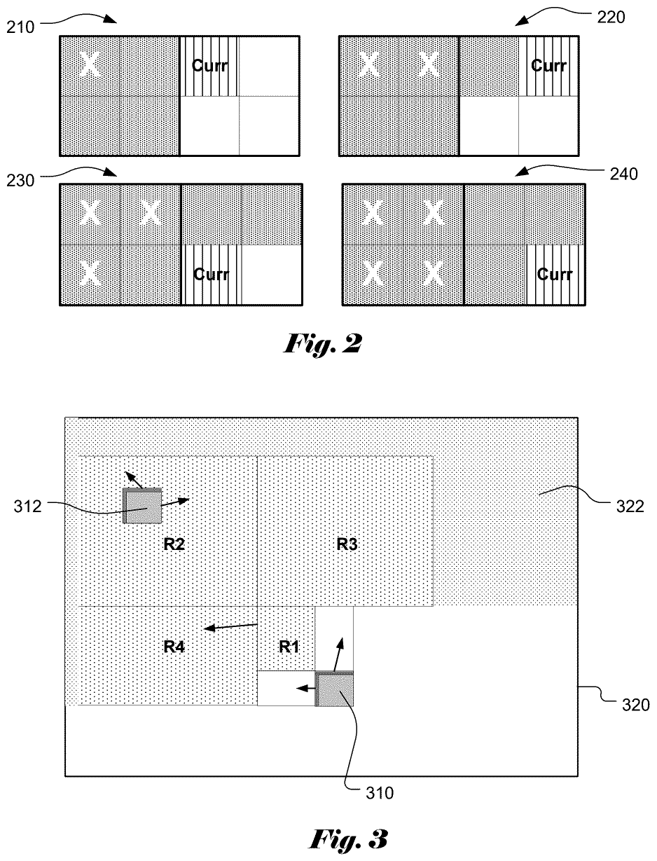

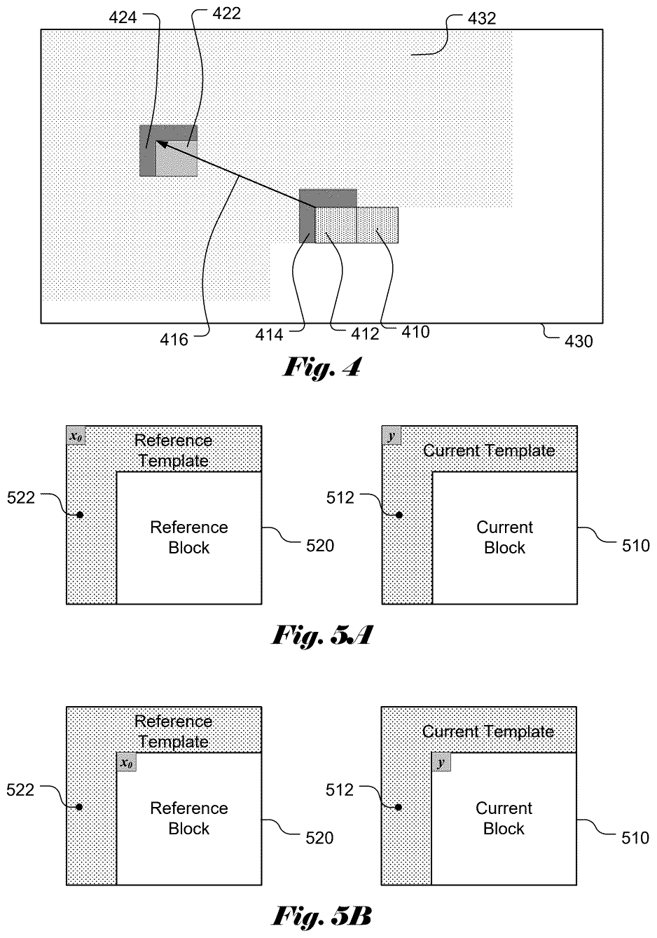

Any of the foregoing proposed filtered predictor methods can be implemented in encoders and/or decoders. For example, any of the proposed filtered predictor methods can be implemented in an inter/intra/predictor derivation module of an encoder, and/or an inter/intra/predictor derivation module of a decoder. Alternatively, any of the proposed methods can be implemented as circuits coupled to the inter/intra/predictor derivation module of the encoder and/or the inter/intra/predictor derivation module of the decoder, so as to provide the information needed by the inter/intra/predictor derivation module. For example, any of the proposed filtered predictor methods can be implemented in an Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A). Any of the proposed filtered predictor methods can also be implemented as a circuit coupled to the intra/inter coding module at the decoder or the encoder. However, the decoder or encoder may also use additional processing unit to implement the required cross-component prediction processing. While the Intra Pred. units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

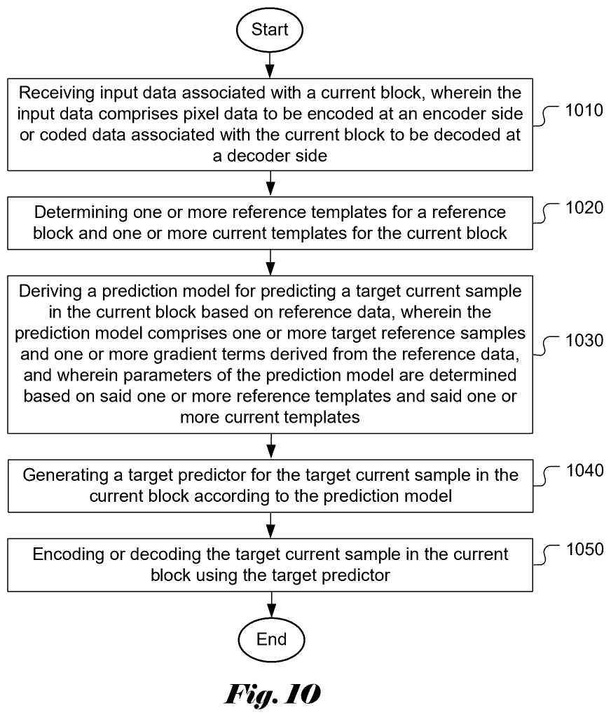

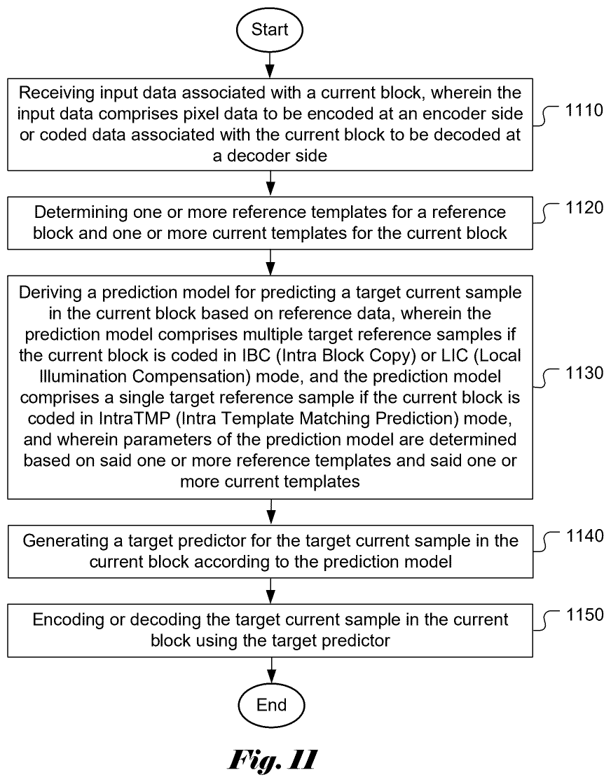

FIG. 10 illustrates a flowchart of an exemplary video coding system that uses filtered predictors with a prediction model including multiple spatial terms and gradient terms according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data associated with a current block are received in step 1010, wherein the input data comprises pixel data to be encoded at an encoder side or coded data associated with the current block to be decoded at a decoder side. One or more reference templates for a reference block and one or more current templates for the current block are determined in step 1020. A prediction model for predicting a target current sample in the current block is derived based on reference data in step 1030, wherein the prediction model comprises one or more target reference samples and one or more gradient terms derived from the reference data, and wherein parameters of the prediction model are determined based on said one or more reference templates and said one or more current templates. A target predictor for the target current sample in the current block is generated according to the prediction model in step 1040. The target current sample in the current block is encoded or decoded using the target predictor in step 1050.

FIG. 11 illustrates a flowchart of another exemplary video coding system that uses filtered predictors with a single source or multiple source prediction model according to an embodiment of the present invention. According to another method, input data associated with a current block are received in step 1110, wherein the input data comprises pixel data to be encoded at an encoder side or coded data associated with the current block to be decoded at a decoder side. One or more reference templates for a reference block and one or more current templates for the current block are determined in step 1120. A prediction model for predicting a target current sample in the current block is derived based on reference data in step 1130, wherein the prediction model comprises multiple target reference samples if the current block is coded in IBC (Intra Block Copy) or LIC (Local Illumination Compensation) mode, and the prediction model comprises a single target reference sample if the current block is coded in IntraTMP (intra Template Matching Prediction)mode, and wherein parameters of the prediction model are determined based on said one or more reference templates and said one or more current templates. A target predictor for the target current sample in the current block is generated according to the prediction model in step 1140. The target current sample in the current block is encoded or decoded using the target predictor in step 1150.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprises pixel data to be encoded at an encoder side or coded data associated with the current block to be decoded at a decoder side;
determining one or more reference templates for a reference block and one or more current templates for the current block;
deriving a prediction model for predicting a target current sample in the current block based on reference data, wherein the prediction model comprises one or more target reference samples and one or more gradient terms derived from the reference data, and wherein parameters of the prediction model are determined based on said one or more reference templates and said one or more current templates;
generating a target predictor for the target current sample in the current block according to the prediction model; and
encoding or decoding the target current sample in the current block using the target predictor.

2. The method of claim 1, wherein the current block is coded in IntraTMP (Intra Template Matching Prediction), IBC (Intra Block Copy) or LIC (Local Illumination Compensation) mode.

3. The method of claim 1, wherein said one or more gradient terms comprise a vertical gradient and a horizontal gradient.

4. The method of claim 1, wherein said one or more target reference samples comprise a corresponding reference sample for the target current sample, a top reference sample, a bottom reference sample, a left reference sample, and a right reference sample of the corresponding reference sample.

5. The method of claim 4, wherein a vertical gradient is calculated according to a first difference between the top reference sample and the bottom reference sample, and a horizontal gradient is calculated based on a second difference between the left reference sample and the right reference sample.

6. The method of claim 4, wherein said one or more target reference samples further comprise a top-right reference sample, a top-left reference sample, a bottom-left reference sample, and a bottom-right reference sample of the target current sample.

7. The method of claim 6, wherein a vertical gradient is calculated according to a first difference between a first sum of the top reference sample, the top-right reference sample and the top-left reference sample and a second sum of the bottom reference sample, the bottom-right reference sample and the bottom-left reference sample, and a horizontal gradient is calculated based on a second difference between a third sum of the left reference sample, the top-left reference sample and the bottom-left reference sample, and a fourth sum of the right reference sample, the top-right reference sample and the bottom-right reference sample.

8. The method of claim 1, wherein said one or more target reference samples or said one or more gradient terms are clipped.

9. The method of claim 8, wherein said one or more target reference samples comprise a corresponding reference sample for the target current sample, intensities of said one or more target reference samples except for the corresponding reference sample are clipped according to a target intensity of the corresponding reference sample.

10. The method of claim 9, wherein the intensities of said one or more target reference samples except for the corresponding reference sample are clipped to a range within a threshold from the target intensity of the corresponding reference sample, wherein the threshold has a positive value.

11. The method of claim 10, wherein the threshold is pre-defined.

12. The method of claim 11, wherein the threshold is dependent on sample bit-depth, slice type, CU width, CU height, prediction direction, quantization parameter, or a combination thereof.

13. The method of claim 10, wherein the threshold is explicitly signalled or parsed at CU level, CTU level, slice level, picture level, or sequence level.

14. The method of claim 8, wherein intensities of said one or more gradient terms are clipped to a range within a threshold from 0, and wherein the threshold has a positive value.

15. The method of claim 14, wherein the threshold is pre-defined.

16. The method of claim 15, wherein the threshold is dependent on sample bit-depth, slice type, CU width, CU height, prediction direction, quantization parameter, or a combination thereof.

17. The method of claim 14, wherein the threshold is explicitly signalled or parsed at CU level, CTU level, slice level, picture level, or sequence level.

18. An apparatus for video coding, the apparatus comprising one or more electronics or processors arranged to:
receive input data associated with a current block, wherein the input data comprises pixel data to be encoded at an encoder side or coded data associated with the current block to be decoded at a decoder side;
determine one or more reference templates for a reference block and one or more current templates for the current block;
derive a prediction model for predicting a target current sample in the current block based on reference data, wherein the prediction model comprises one or more target reference samples and one or more gradient terms derived from the reference data, and wherein parameters of the prediction model are determined based on said one or more reference templates and said one or more current templates;
generate a target predictor for the target current sample in the current block according to the prediction model; and
encode or decode the target current sample in the current block using the target predictor.

19. A method of video coding, the method comprising:
receiving input data associated with a current block, wherein the input data comprises pixel data to be encoded at an encoder side or coded data associated with the current block to be decoded at a decoder side;
determining one or more reference templates for a reference block and one or more current templates for the current block;
deriving a prediction model for predicting a target current sample in the current block based on reference data, wherein the prediction model comprises multiple target reference samples if the current block is coded in IBC (Intra Block Copy) or LIC (Local Illumination Compensation) mode, and the prediction model comprises a single target reference sample if the current block is coded in IntraTMP (Intra Template Matching Prediction) mode, and wherein parameters of the prediction model are determined based on said one or more reference templates and said one or more current templates;
generating a target predictor for the target current sample in the current block according to the prediction model; and
encoding or decoding the target current sample in the current block using the target predictor.

20. An apparatus for video coding, the apparatus comprising one or more electronics or processors arranged to:
receive input data associated with a current block, wherein the input data comprises pixel data to be encoded at an encoder side or coded data associated with the current block to be decoded at a decoder side;
determine one or more reference templates for a reference block and one or more current templates for the current block;
derive a prediction model for predicting a target current sample in the current block based on reference data, wherein the prediction model comprises multiple target reference samples if the current block is coded in IBC (Intra Block Copy) or LIC (Local Illumination Compensation) mode, and the prediction model comprises a single target reference sample if the current block is coded in IntraTMP (Intra Template Matching Prediction) mode, and wherein parameters of the prediction model are determined based on said one or more reference templates and said one or more current templates;
generate a target predictor for the target current sample in the current block according to the prediction model; and
encode or decode the target current sample in the current block using the target predictor.
